(19) United States
(12) Patent Application Publication
(10) Pub. No.: US 2018/0141082 A1
(43) Pub. Date: May 24, 2018

(54) METHOD FOR COATING INTERNAL SURFACES

(71) Applicant: Caterpillar Inc., Peoria, IL (US)

(72) Inventor: John M. Spangler, Peoria, IL (US)

(73) Assignee: Caterpillar Inc., Peoria, IL (US)

(21) Appl. No.: 15/356,828

(22) Filed: Nov. 21, 2016

(51) Int. Cl. B05D 7/22; B05D 3/06

(52) U.S. Cl. CPC B05D 7/222; B05D 2254/04; B05D 3/06

(57) ABSTRACT

A method for coating an internal surface of a component including preparing the internal surface, coating with chemical deposition fluid and curing the coating, is provided. The method includes flushing the internal surface with a supercritical fluid, for preparing the internal surface. The method further includes flushing the internal surface with a chemical deposition fluid such the chemical deposition fluid creates a coating on the internal surface. The method further includes curing the coating with an infrared heat source.

### TECHNICAL FIELD

The present disclosure relates to coating an internal surface of a component, and more particularly, to a method for coating an internal surface of a component using chemical deposition.

### BACKGROUND

Metallic components manufactured for use with on-highway or off-highway machines, for example, may undergo a series of finishing processes that enhance the strength and/or durability of the components, such as to withstand harsh operating conditions of the machine. Finishing processes may include coating the components with one or more coating compositions that provide protection from corrosion, weathering, ultraviolet degradation, and other environmental factors that may damage the underlying metallic component. Conventionally, internal surfaces of metallic components are coated using electro-coating methods, also known as e-coating. It has been found that it is ordinarily difficult to coat recessed internal surfaces of components, especially interior regions of hollowed out metallic substrates using e-coating technique, as these interior surfaces typically get limited internal coating coverage due to the component geometry using such conventional techniques.

U.S. Pat. No. 8,709,535, hereinafter referred to as the '535 patent, relates to a method of enhancing corrosion resistance of a hollow vessel. The method of the '535 patent includes providing a hollow vessel including a wall defining a cavity, providing a coating tank filled with a liquid coating having charged coating elements, submerging the hollow vessel into the liquid coating, allowing the liquid coating to pass into the cavity through at least one aperture of the wall, coating the exterior surface of the wall with a portion of the coating elements, coating the interior surface of the wall with an additional portion of the coating elements, removing the hollow vessel from the coating tank, draining the liquid coating from the cavity, heating the hollow vessel in an oven, and curing the portion of the coating elements on the exterior surface and curing the additional portion of the coating elements on the interior surface.

It may be understood that the '535 patent is generally used for components with open and wide internal regions, such as fuel tanks or the like. The method of coating as disclosed in '535 patent may not be particularly applicable to provide uniform coatings for components with recessed internal surfaces, such as tubular components.

### SUMMARY

In one aspect of the present disclosure, a method for coating an internal surface of a component is described. The method includes flushing the internal surface with a supercritical fluid. The method further includes flushing the internal surface with a chemical deposition fluid, such that the chemical deposition fluid creates a coating on the internal surface. The method further includes curing the coating with an infrared heat source.

In another aspect of the present disclosure, a method for coating an internal surface of a component is described. The method includes flushing the internal surface with a chemical deposition fluid, such that the chemical deposition fluid creates a coating on the internal surface. The method further includes curing the coating with an infrared heat source applied externally to the component at a reduced pulsed power.

In yet another aspect of the present disclosure, a method for coating a surface of a component is described. The method includes flushing the surface with a supercritical fluid. The method also includes recovering the supercritical fluid for recycling thereof. The method further includes flushing the surface with a chemical deposition fluid, such that the chemical deposition fluid creates a coating on the surface. The method also includes rinsing the surface to remove excess chemical deposition fluid. The method further includes curing the coating with an infrared heat source applied externally to the component at a reduced pulsed power.

Other features and aspects of this disclosure will be apparent from the following description and the accompanying drawings.

### BRIEF DESCRIPTION OF THE DRAWINGS

FIG. 1 illustrates a side diagrammatic view of a machine, in accordance with one or more embodiments of the present disclosure;

FIG. 2 illustrates a perspective view of a component that may be supported on the machine of FIG. 1, in accordance with one or more embodiments of the present disclosure;

FIG. 3 illustrates a flowchart of a method for coating an internal surface of the component, in accordance with a first embodiment of the present disclosure;

FIG. 4 illustrates a flowchart of a method for coating an internal surface of the component, in accordance with a second embodiment of the present disclosure; and

FIG. 5 illustrates a flowchart of a method for coating an internal surface of the component, in accordance with a third embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

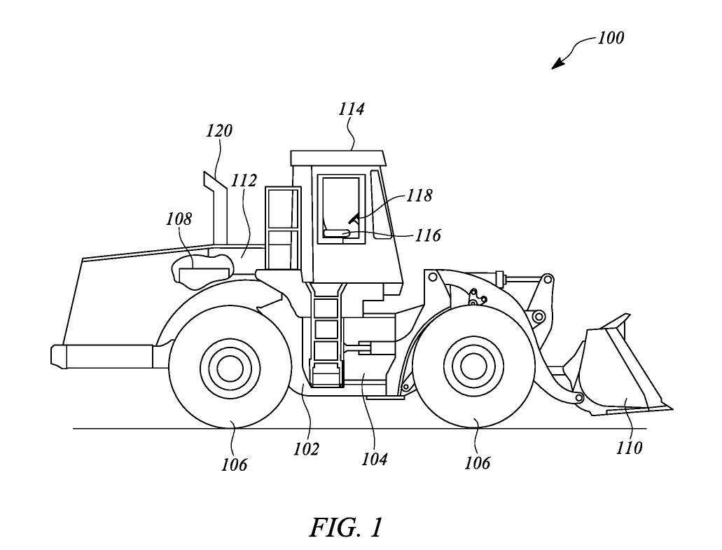

An exemplary embodiment of a machine 100 is shown generally in FIG. 1. The machine 100 may be a wheel loader, as shown, or any other on-highway or off-highway vehicle used to perform work operations. As shown in the illustrated embodiment, the machine 100 may generally include a chassis 102 having a drive system 104 supported thereon for driving wheels 106 of the machine 100. An internal combustion engine 108, also supported on the chassis 102, may provide power to the drive system 104 and to additional systems requiring power, such as, for example, a hydraulic system (not shown) used for controlling an implement 110 of the machine 100.

A machine body, shown generally as 112, may also be mounted on the chassis 102 for housing and/or supporting one or more components of the machine 100, such as, for example, the drive system 104, the internal combustion engine 108, and the hydraulic system, as described above. Similarly, an operator control station 114 may be mounted on the chassis 102, or machine body 112, for housing and/or supporting devices that facilitate operator control, such as, for example, a seat assembly 116 and a steering device 118. It should be appreciated, however, that the machine 100, as described herein, has been simplified for exemplary purposes, and is in no way meant to be limited to the specific systems or structures described.

The chassis 102, the machine body 112, the operator control station 114, and/or other modules of the machine 100 may, generally, include one or more components 120. The components 120, as described herein, may be used as a component to assemble modules of the machine 100, for example, parts of the machine body 112; and/or may be involved in operation of the machine 100, for example for transferring of fluids to different modules of the machine 100. For instance, the component 120 may be a hollow cylindrical pipe being used in the internal combustion engine 108 or the hydraulic system of the machine 100. In other instances, the component 120 may be a container or a tank having surfaces with complex geometry, for example having internal cavities. In the exemplary embodiment of FIG. 1, the component 120 is shown as an exhaust pipe attached to the machine body 112. Although an exemplary context is provided, the component 120 may not be limited to on-highway or off-highway machines, but may be applicable for use with various other products requiring similar performance characteristics to those described herein.

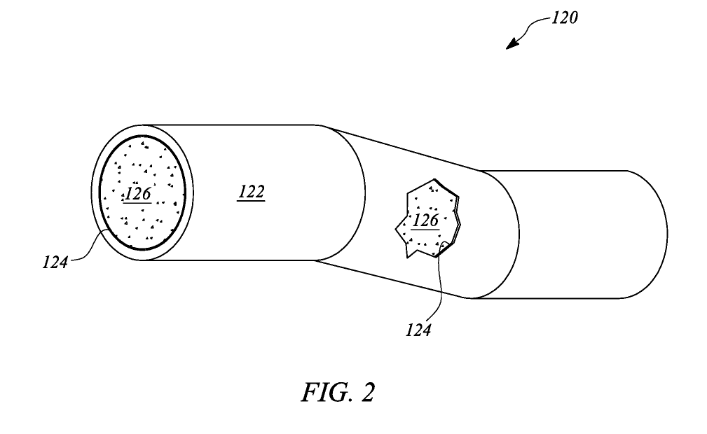

A simplified embodiment of the component 120 is illustrated in FIG. 2. In the illustrated example, the component 120 is shown as a pipe, generally tubular in shape with some bends. Such component 120 may be used for transferring different fluids to various systems in the machine 100. However, it may be contemplated that the component 120 may not be limited to tubular structures and includes structures with planar surfaces, and generally be of any geometric shape. In one example, the component 120 may be made of a metallic material, or specifically ferrous material. It may be understood that for the purposes of the present disclosure, the component 120 may be a newly fabricated component, or may be a refurbished component, i.e., a component that has been previously used in the machine 100. As such, the component 120 may have any shape, size, or composition for the purposes of the present disclosure.

As illustrated in FIG. 2, the component 120 may include an external surface 122 and an internal surface 124. In an embodiment, the internal surface 124 of the component 120 may provide a metallic substrate. In particular, the metallic substrate may be made of a ferrous material, such as iron, steel, and alloys thereof. It may be understood that the component 120 may provide sharp edges and crevices because of the bends therein, as generally shown in the example of FIG. 2. In particular, the internal surface 124 of the component 120 may have these sharp edges and crevices. In accordance with the embodiments of the present disclosure, the internal surface 124 of the component 120 is provided with a coating 126. The coating 126 may substantially conform to the profile of the internal surface 124, of the component 120. It may be understood that the coating 126 of the present disclosure may substantially cover discontinuities on the internal surface 124 of the component 120, including, but not limited to, crevices, points, pores, cracks, sharp edges, etc.

According to one embodiment of the present disclosure, the internal surface 124 of the component 120 may be first prepared for applying the coating 126 thereto. The preparation stage may include one or more steps. In some embodiments, the internal surface 124 may be prepared by any process configured to clean and prepare the internal surface 124 before applying the coating 126. For example, the internal surface 124 may be cleaned of any rust, grease, dirt, dust, oils, debris, and any organic residues (hereinafter generally referred to as “contaminants”) that may be adhered thereto and interfere with the coating process. For remanufactured components, these contaminants may also include remnants of the previous coating, i.e., all or some part of the worn coating may also be removed from the internal surface 124, of the component 120. It may be understood that in some cases the preparation stage may not be necessary, as in the case of a newly manufactured component.

In one embodiment, the process for cleaning the internal surface 124 of the component 120 includes flushing the internal surface 124 with a supercritical fluid. In some examples, the component 120 may be dipped, or immersed, into a tank filed with the supercritical fluid, such that the internal surface 124 is flushed with the supercritical fluid. In other examples, the supercritical fluid may be sprayed at the internal surface 124 of the component 120. According to an embodiment, the supercritical fluid is one of supercritical carbon-dioxide (CO₂) and liquid nitrogen (N₂), however any other suitable supercritical fluids may be used for the purpose without any limitations. Generally, these supercritical fluids have extremely low viscosity (low surface tension) and superior solvent properties than the liquid phase. For example, unlike other cleaning liquids, CO₂ in its supercritical state with almost no surface tension has the permeability to reach all of the crevices of the internal surface 124 of the component 120. Further being non-polar, CO₂ has the capacity to dissolve a variety of non-polar materials or contaminates adhered to the internal surface 124. Therefore, supercritical CO₂ may go deeply into the smallest interstices of the internal surface 124 and completely clean the internal surface 124. Subsequent to cleaning the internal surface 124, the supercritical fluid may be recovered and recycled by conventional techniques for further use.

In alternate examples, the internal surface 124 of the component 120 may be cleaned, and/or degreased, using other known physical or chemical means. For example, a cleaning agent, such as any commercially available alkaline or acidic cleaning agents, may be used. Alternatively, or additionally, water may be used to wash the internal surface 124 of the component 120. It may be contemplated that mechanical cleaning, chemical-assisted cleaning, chemical stripping, and/or abrasive blasting may also be used to prepare the internal surface 124 of the component 120 before applying the coating 126.

Following cleaning, the component 120 may optionally be rinsed with water, such as tap water or de-ionized water, in order to remove any leftover residues of the cleaning agent, and then dried. In some examples, the internal surface 124 may also be treated with a layer of pretreatment chemicals, as should be appreciated by those skilled in the art. Pretreatment chemicals are well known and may be selected, based on the composition of the metallic substrate of the internal surface 124 including certain environmental considerations, to improve adhesion of the coating 126 to the internal surface 124 and/or to improve performance characteristics of the metallic substrate, such as, for example, corrosion resistance.

As mentioned earlier, the internal surface 124 of the component 120 is provided with the coating 126 subsequent to the aforementioned preparation stage. It should be understood that that the coating 126 may be applied to the entire internal surface 124 of the component 120, including both the continuous and non-continuous surfaces. The coating 126 may be provided by flushing the internal surface 124 with a chemical deposition fluid. In one example, the coating 126 may be applied to the internal surface 124 by spraying the chemical deposition fluid at the internal surface 124, for example, by means of a mister, a sprayer, a dispenser, etc. In other examples, the coating 126 may be applied to the internal surface 124 by brushing the chemical deposition fluid to the internal surface 124. It may be appreciated that other known methods may be employed for flushing the internal surface 124 with the chemical deposition fluid without limiting the scope of the present disclosure. On application of the chemical deposition fluid to the internal surface 124, the chemical deposition fluid may form a thin layer thereof over the internal surface 124. In some examples, the chemical deposition fluid may be applied over the internal surface 124 in a manner, such that the formed layer has a uniform thickness throughout the internal surface 124. Further, in some examples, the chemical deposition fluid may be applied in a manner such that the resultant thickness of the formed layer over the internal surface 124 is less than 2 mils (1 mil=0.001 inches).

According to one embodiment of the present disclosure, the chemical deposition fluid, as employed for applying the coating 126 to the internal surface 124 of the component 120, may include any known autodepositable coating compositions, including, but not limited to, Autophoretic® or Autophoretic Coating Chemicals (ACC®) provided by Henkel Surface Technologies. Autodeposition is a known technique and generally includes the application of a waterborne coating layer on a metallic surface (usually ferrous, but may be aluminum, titanium, etc.) by means of a chemical reaction. Generally, the chemical deposition fluid may include an epoxy-acrylic based resin; however, other autodepositable coating compositions may alternatively be selected for the purpose of the present disclosure.

In some examples, after application of the chemical deposition fluid, the internal surface 124 may undergo one or more rinse stages before proceeding with the subsequent steps. For example, the component 120 may undergo a first rinse to remove any excess chemical deposition fluid that has not deposited on the internal surface 124. More than one rinsing steps may be employed to maintain the thickness of the layer of chemical deposition fluid within the desired limit. In some examples, the rinse may involve using pressurized air to push out the excess chemical deposition fluid. In some examples, an additional reaction rinse may be provided to impart new properties, such as, for example, increased corrosion resistance, to the layer of chemical deposition fluid, and thereby the coating 126 as formed on the internal surface 124 of the component 120.

According to an embodiment of the present disclosure, after the preparing and optional rinse stages, the component 120 may be heated to a temperature sufficient to cure the layer of chemical deposition fluid to form the coating 126 over the internal surface 124. Specifically, the internal surface 124 may be heated to a target temperature for a predetermined period of time to sufficiently cure the layer of chemical deposition fluid according to its specifications. In some examples, the curing process may involve heating the layer of chemical deposition fluid to a temperature in the range of 220° F. to 375° F. for about 2-3 minutes, to form the coating 126. In other examples, the curing may take place with the temperature of the component 120, or specifically the temperature of the internal surface 124 of the component 120, reaching up to 450° F.

In one embodiment, the layer of chemical deposition fluid over the internal surface 124 of the component 120 may be cured by using an infrared heat source. The infrared heat may be applied externally to the component 120. That is, the heat is applied to the external surface 122 of the component 120 by infrared radiation, which in turn heats the internal surface 124 and thereby the layer of chemical deposition fluid in contact therewith by conduction. It may be understood that an inner side of the layer of the chemical deposition fluid is first cured, thereby providing better coating 126 over the internal surface 124.

In some examples, the infrared heat source may be a gas or an electric oven having an enclosure supporting an internal array of infrared radiant elements, such that the component 120 may be positioned in the enclosure of the oven for carrying out the curing process. In alternate examples, the infrared heat source may be an induction coil. By positioning the component 120 inside the infrared heat source with accurately calibrated conditions, the component 120 may be uniformly heated and furthermore curing of the layer of chemical deposition fluid may take place relatively rapidly. Generally, such conventionally available ovens include infrared radiant elements or lamps which can raise temperatures inside the oven up to 1500° F. According to one embodiment of the present disclosure, the infrared heat source is applied at a reduced pulsed power, for example the pulsating lamps are set at 20%-30% of full power, for proper curing of the layer of chemical deposition fluid to form the coating 126 over the internal surface 124.

It may be contemplated that the above described stages of applying the coating 126 to the internal surface 124 of the component 120 may be repeated until thickness of the coating 126 is at a desired value. For example, after the component 120 is heated, the formed coating 126 may be subjected to an inspection. The inspection may include measuring thickness to determine if thickness of the formed coating 126 is at a desired value. The inspection may also include measuring thickness at different location on the internal surface 124 to determine if the thickness of the formed coating 126 is uniform. The inspection may optionally include other measurements to determine if the formed coating 126 is desirable. The inspection may be automated, manual, or semi-automated inspection. In some cases, the internal surface 124 may be subjected to sequential applications of the chemical deposition fluid using the spraying device or the like, with curing after each application to form the coating 126 of desired thickness and properties.

It may also be contemplated that the process of applying the chemical deposition fluid, for example with the spraying device, may be automated, manual, or semi-automated. Similarly, it may be contemplated that the process of heating of the component 120 may be automated, manual, or semi-automated. For example, an electronic control unit (not illustrated) may be connected to the spraying device and the infrared heat source. The electronic control unit may be configured to control the amount and the rate of the chemical deposition fluid applied to the internal surface 124 by controlling the spraying device, and also the heating time and temperature of the component 120 by calibrating the infrared heat source.

### INDUSTRIAL APPLICABILITY

It is well known that the components that are fabricated for use with on-highway or off-highway machines are prone to corrosion, which is particularly common in components such as, for example, tanks, tubes and the like. Corrosion phenomenon particularly affects the internal surfaces of such components as these are more exposed to chemicals passing therefrom. Traditionally, these components are coated, for example with powder coating composition, which may be applied to its surfaces using electrodeposition techniques, such as, electrostatic spraying. Although the electrodeposition techniques may be directed to provide coating over the entire surface of the component, it may be appreciated that certain areas may inhibit the electrostatic application of the coating. This condition, known as the Faraday cage effect, may prevent proper application of the coating along edges, corners, recesses, channels, or other areas that do not represent continuous surfaces. Other known techniques such as, chemical deposition may be employed but has limitations, for example, it may only work with components having simple geometry and further require the whole component to be immersed in chemical bath, which is very cumbersome. Therefore, coating internal areas of pipes, tanks, and other similar components with internal cavities is extremely challenging, especially on large complex geometries.

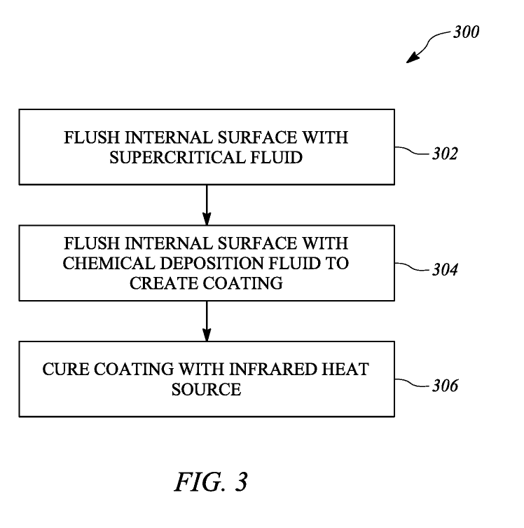

According to a first embodiment, the present disclosure provides a method 300 for coating the internal surface 124 of the component 120 as illustrated in the form of a flow chart in FIG. 3. In block 302, the method 300 includes flushing the internal surface 124 of the component 120 with the supercritical fluid. This involves either spraying the supercritical fluid at the internal surface 124 of the component 120 or immersing the component 120 in the supercritical fluid. In block 304, the method 300 includes flushing the internal surface 124 with the chemical deposition fluid. This involves spraying the chemical deposition fluid at the internal surface 124 of the component 120. The chemical deposition fluid creates the coating 126 on the internal surface 124 of the component 120. Further, in block 306, the method 300 includes curing the coating 126 with the infrared heat source. In some examples, the curing of the coating 126 takes place when a temperature of the component 120, or specifically the temperature of the internal surface 124 of the component 120, is in the range of 220° F. to 375° F. In some examples, the resultant thickness of the coating 126 as formed over the internal surface 124 of the component 120 is within 2 mils.

The method 300 is particularly applicable where the component 120 is made of ferrous material. In one example, the supercritical fluid used for preparing the internal surface 124 is one of the supercritical carbon-dioxide and liquid nitrogen, and the chemical deposition fluid used may be an epoxy-acrylic based resin. Further, the infrared heat source employed may be the gas oven or the electric oven. In one example, the infrared heat source is applied externally to the component 120. Further, the infrared heat source is applied at a reduced pulsed power. The method 300 may also involve recovering the supercritical fluid for recycling thereof, before flushing the internal surface 124 with the chemical deposition fluid. Furthermore, the method 300 may involve rinsing the internal surface 124 to remove excess chemical deposition fluid before curing, to form the coating 126.

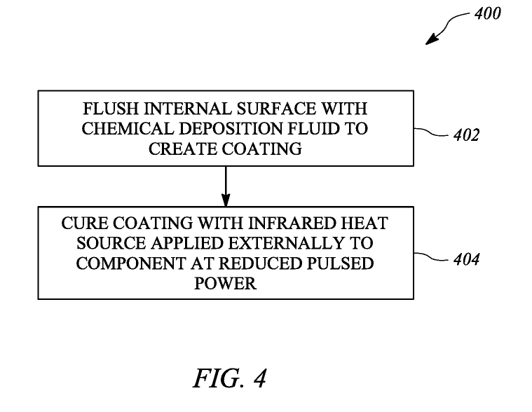

According to a second embodiment, the present disclosure provides a method 400 for coating the internal surface 124 of the component 120 as illustrated in the form of a flow chart in FIG. 4. In block 402, the method 400 includes flushing the internal surface 124 of the component 120 with a chemical deposition fluid to create the coating 126 on the internal surface 124. In block 402, the method 400 includes curing the coating 126 with the infrared heat source applied externally to the component 120 at a reduced pulsed power.

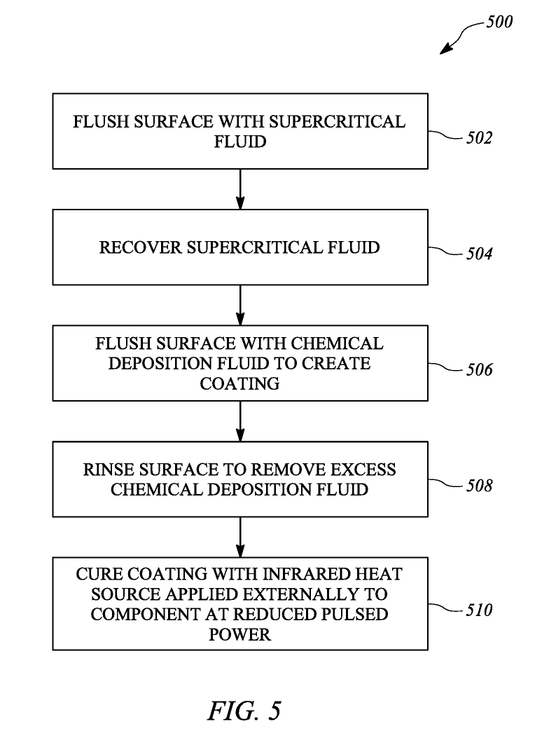

It may be contemplated by a person skilled in the art that although the methods of the present disclosure has been implemented for coating the internal surface 124 of the components 120; the present methods may also be implemented to coat the external surface 122 of the component 120, without much modifications. According to a third embodiment, the present disclosure provides a method 500 for coating a surface of the component 120 as illustrated in the form of a flow chart in FIG. 5. In block 502, the method 500 includes flushing the surface of the component 120 with the supercritical fluid. In block 504, the method 500 includes recovering the supercritical fluid for recycling thereof. Further, in block 506, the method 500 includes flushing the surface of the component 120 with the chemical deposition fluid to create the coating 126 on the surface. In block 508, the method 500 includes rinsing the surface of the component 120 to remove excess chemical deposition fluid. Finally, in block 510, the method 500 includes curing the coating 126 with the infrared heat source applied externally to the component 120 at a reduced pulsed power. The surface, as described herein, may include one or both of the external surface 122 and the internal surface 124 of the component 120.

The present disclosure may be applicable to components with ferrous metallic substrates, or other metallic substrates, that are fabricated for use with on-highway or off-highway machines. Specifically, the present disclosure finds potential application for coating any metallic substrate having a coated surface for enhancing physical, chemical, or aesthetic qualities of the metallic substrate. Further, the disclosure may be specifically applicable to ferrous metallic substrates that may require protection from corrosion, weathering, ultraviolet degradation, and/or other environmental factors. The term corrosion is used in a broad sense in this disclosure. For instance, any interaction between the substrate and its environment that results in a degradation of the physical, mechanical, or aesthetic properties of the substrate is corrosion of the substrate. One skilled in the art may understand that the process of the present invention may also be employed for coating non-automotive metal and/or polymeric components.

The coating 126 as formed by the disclosed methods of the present disclosure cover discontinuities on the internal surface 124 of the component 120, including crevices, points, pores, cracks, sharp edges, etc. Therefore, the coating 126 as formed by the present disclosure may provide better protection for the component 120, reducing the need for regular maintenance and thus improving the overall economics of the operation of the machine 100. The methods of the present disclosure may also enable easy reapplication of the coating 126 to the component 120 where a prior coating has worn off. By using the chemical deposition technique, the present methods eliminate the need of large and expensive setups as required for implementing the conventional electrostatic coating process.

While aspects of the present disclosure have been particularly shown and described with reference to the embodiments above, it will be understood by those skilled in the art that various additional embodiments may be contemplated by the modification of the disclosed machines and assemblies without departing from the spirit and scope of what is disclosed. Such embodiments should be understood to fall within the scope of the present disclosure as determined based upon the claims and any equivalents thereof.

What is claimed is:

1. A method for coating an internal surface of a component, comprising:
flushing the internal surface with a supercritical fluid;
flushing the internal surface with a chemical deposition fluid, the chemical deposition fluid creating a coating on the internal surface; and
curing the coating with an infrared heat source.

2. The method of claim 1, wherein the infrared heat source is applied externally to the component.

3. The method of claim 1, wherein the infrared heat source is applied at a reduced pulsed power.

4. The method of claim 1 further comprising, recovering the supercritical fluid for recycling thereof, before flushing the internal surface with the chemical deposition fluid.

5. The method of claim 1 further comprising, rinsing the internal surface to remove excess chemical deposition fluid, before curing the coating.

6. The method of claim 1, wherein flushing the internal surface with the supercritical fluid comprises either spraying the supercritical fluid at the internal surface of the component or immersing the component in the supercritical fluid.

7. The method of claim 1, wherein flushing the internal surface with the chemical deposition fluid comprises spraying the chemical deposition fluid at the internal surface of the component.

8. The method of claim 1, wherein the supercritical fluid is one of supercritical carbon-dioxide and liquid nitrogen.

9. The method of claim 1, wherein the chemical deposition fluid is an epoxy-acrylic based resin.

10. The method of claim 1, wherein the curing of the coating takes place at a temperature of the component in the range of 220° F. to 375° F.

11. The method of claim 1, wherein the infrared heat source is one of a gas oven and an electric oven.

12. The method of claim 1, wherein a thickness of the coating is less than 2 mils.

13. The method of claim 1, wherein the component is comprised of a ferrous material.

14. A method for coating an internal surface of a component, comprising:
flushing the internal surface with a chemical deposition fluid, the chemical deposition fluid creating a coating on the internal surface; and
curing the coating with an infrared heat source applied externally to the component at a reduced pulsed power.

15. The method of claim 14 further comprising, flushing the internal surface with a supercritical fluid, before flushing the internal surface with the chemical deposition fluid.

16. The method of claim 15, wherein flushing the internal surface with the supercritical fluid comprises either spraying the supercritical fluid at the internal surface of the component or immersing the component in the supercritical fluid.

17. The method of claim 15 further comprising, recovering the supercritical fluid for recycling thereof, before flushing the internal surface with the chemical deposition fluid.

18. A method for coating a surface of a component, comprising:
flushing the surface with a supercritical fluid;
recovering the supercritical fluid for recycling thereof;
flushing the surface with a chemical deposition fluid, the chemical deposition fluid creating a coating on the surface;
rinsing the surface to remove excess chemical deposition fluid; and
curing the coating with an infrared heat source applied externally to the component at a reduced pulsed power.

19. The method of claim 18, wherein the surface is an internal surface of the component.

20. The method of claim 18, wherein the surface is an external surface of the component.
